(19) United States
(12) Patent Application Publication
(10) Pub. No.: US 2024/0318019 A1
(43) Pub. Date: Sep. 26, 2024

(54) SOLID SOLUTION PIGMENT, AQUEOUS PIGMENT DISPERSION LIQUID, AND AQUEOUS INK

(71) Applicant: CANON KABUSHIKI KAISHA, Tokyo (JP)

(72) Inventors: YOKO UETAKE, Kanagawa (JP); RYOSUKE NAGAO, Kanagawa (JP); TARO ENDO, Kanagawa (JP); TSUYOSHI KASAI, Tokyo (JP); RYUYA HIRAOKA, Kanagawa (JP)

(21) Appl. No.: 18/609,258

(22) Filed: Mar. 19, 2024

(30) Foreign Application Priority Data
Mar. 22, 2023 (JP) 2023-045793
Mar. 6, 2024 (JP) 2024-034106

(51) Int. Cl. C09D 11/322; C09B 67/22; C09D 11/037

(52) U.S. Cl. CPC C09D 11/322; C09B 67/0033; C09D 11/037

(57) ABSTRACT

Provided are: a solid solution pigment using a quinacridone pigment, the solid solution pigment being excellent in dispersibility; and an aqueous pigment dispersion liquid and an aqueous ink each using the solid solution pigment. The solid solution pigment is a solid solution pigment of C.I. Pigment Violet 19 and a first compound. The solid solution pigment is characterized in that the first compound is a compound represented by the following chemical formula (1) or a compound represented by the following chemical formula (2). In addition, the aqueous pigment dispersion liquid and the aqueous ink each include the solid solution pigment.

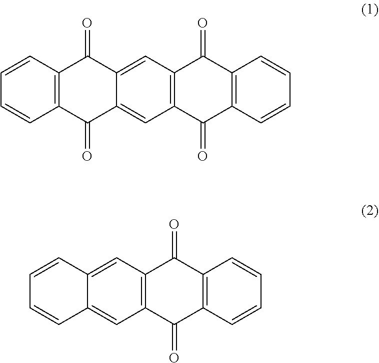 [SMILES: O=c1c2ccccc2c(=O)c2cc3c(=O)c4ccccc4c(=O)c3cc12 ; O=C1c2ccccc2C(=O)c2cc3ccccc3cc21]

### BACKGROUND OF THE INVENTION

### Field of the Invention

The present invention relates to a solid solution pigment, an aqueous pigment dispersion liquid, and an aqueous ink.

### Description of the Related Art

In recent years, an inkjet recording apparatus has enabled the recording of such a high-definition image having high color developability as achieved by silver halide photography or offset printing relatively easily and at a low cost even in a general household. In addition, for improvement in color developability of a recorded article, a quinacridone solid solution of any of various combinations has been proposed and used as a pigment that may be used as a coloring material. For example, in Japanese Patent Application Laid-Open No. 2002-146224, there is a proposal of a quinacridone solid solution pigment formed of unsubstituted quinacridone (C.I. Pigment Violet 19) and 4,11-dichloroquinacridone.

### SUMMARY OF THE INVENTION

The present invention is directed to provide a solid solution pigment using a quinacridone pigment, the solid solution pigment being excellent in dispersibility. The present invention is also directed to provide an aqueous pigment dispersion liquid and an aqueous ink each using the solid solution pigment.

That is, according to one aspect of the present invention, there is provided a solid solution pigment of C.I. Pigment Violet 19 and a first compound, wherein the first compound is one of a compound represented by the following chemical formula (1) or a compound represented by the following chemical formula (2).

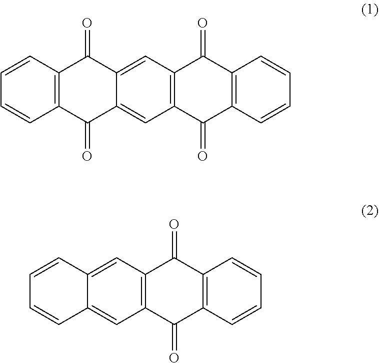 [SMILES: O=c1c2ccccc2c(=O)c2cc3c(=O)c4ccccc4c(=O)c3cc12 ; O=C1c2ccccc2C(=O)c2cc3ccccc3cc21]

In addition, according to another aspect of the present invention, there is provided an aqueous pigment dispersion liquid including the solid solution pigment.

In addition, according to another aspect of the present invention, there is provided an aqueous ink including the solid solution pigment.

Further features of the present invention will become apparent from the following description of exemplary embodiments with reference to the attached drawings.

### BRIEF DESCRIPTION OF THE DRAWINGS

FIG. 1 is a sectional view for schematically illustrating an ink cartridge according to one embodiment.

FIG. 2A and FIG. 2B are views for schematically illustrating an example of an inkjet recording apparatus to be used in an inkjet recording method, in which FIG. 2A is a perspective view of the main portion of the inkjet recording apparatus and FIG. 2B is a perspective view of a head cartridge.

### DESCRIPTION OF THE EMBODIMENTS

A quinacridone solid solution pigment has involved a problem in that when the pigment is used as ultrafine particles for use in an inkjet recording method, the particles are liable to aggregate. When the particle diameters of primary particles are too small, an aggregation force is strong, and hence dispersion may become difficult. Also in Japanese Patent Application Laid-Open No. 2002-146224, there is a description that it is required that an X-ray diffraction (XRD) intensity be equal to or more than a predetermined intensity and a crystallite size be equal to or more than a certain size.

Accordingly, the inventors of the present invention have made extensive investigations on a solid solution pigment excellent in dispersibility, and an aqueous pigment dispersion liquid and an aqueous ink each using the solid solution pigment. Thus, the inventors have reached the present invention.

The present invention is described in more detail below by way of exemplary embodiments. In the present invention, when a compound is a salt, the salt is present as dissociated ions in an ink, but the expression “contain a salt” is used for convenience. In addition, an aqueous inkjet ink is sometimes referred to simply as “ink”. Further, the term “unit” with regard to a resin refers to a minimum repeating unit for forming the resin, and refers to a structure formed by (co)polymerization of one monomer. Physical property values are values at normal temperature (25° C.), unless otherwise stated.

The term “solid solution” refers to a solid in which a plurality of different molecules are present in a mixed state of being dissolved in each other and in a uniform solid phase state, and does not refer to a simple mixture of a plurality of different compounds. The term “solid solution pigment” as used herein means a solid solution in which at least one kind of molecule for forming the solid solution is a pigment. The content (mass %) of the pigment in the solid solution pigment is preferably 50 mass % or more with respect to the total mass of the solid solution pigment. In addition, the term “peak position of X-ray diffraction” as used herein means a diffraction angle 2θ when an X-ray diffraction pattern measured by X-ray diffractometry has a high diffraction intensity.

### <Solid Solution Pigment>

A solid solution pigment of the present invention (hereinafter sometimes simply referred to as “solid solution pigment”) is a solid solution pigment of C.I. Pigment Violet 19 and a first compound. The first compound is a compound represented by the following chemical formula (1) or a compound represented by the following chemical formula (2).

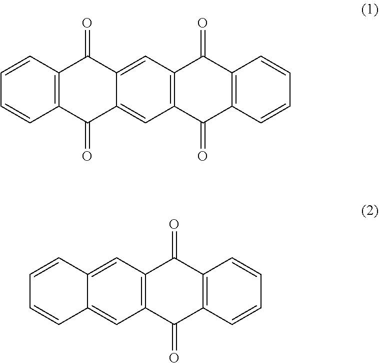 [SMILES: O=c1c2ccccc2c(=O)c2cc3c(=O)c4ccccc4c(=O)c3cc12 ; O=C1c2ccccc2C(=O)c2cc3ccccc3cc21]

The solid solution pigment of the present invention is required to be a solid solution of C.I. Pigment Violet 19 serving as a quinacridone pigment and the first compound (the compound represented by the chemical formula (1) or the compound represented by the chemical formula (2)). C.I. Pigment Violet 19 is quinacridone (molecular formula: C₂₀H₁₂N₂O₂) free of a substituent. The compound represented by the chemical formula (1) is also referred to as “5,7,12,14-pentacenetetrone”. The compound represented by the chemical formula (2) is also referred to as “5,12-naphthacenequinone”.

The compounds represented by the chemical formula (1) and the chemical formula (2) each have a higher ratio of oxygen atoms in a molecule than that of C.I. Pigment Violet 19 in addition to the fact that a skeleton thereof is similar to that of quinacridone. Accordingly, hydrogen bonding to a surface of the solid solution pigment becomes easy by virtue of the oxygen atoms in the molecule of the first compound (the compound represented by the chemical formula (1) or the compound represented by the chemical formula (2)). In addition, it is conceived that aggregation between the pigments is suppressed by an interaction with, for example, an ambient water molecule or a resin dispersant, and hence the dispersibility is improved.

A mass ratio of a content of the first compound with respect to a content of C.I. Pigment Violet 19 (content of the first compound/content of C.I. Pigment Violet 19) in the solid solution pigment is preferably 0.10 or more and less than 1.00. When the mass ratio of the content (usage amount) of the first compound with respect to the content (usage amount) of C.I. Pigment Violet 19 in the solid solution pigment is 0.10 or more, the dispersibility of the solid solution pigment is more easily improved. Meanwhile, when the mass ratio of the content (usage amount) of the first compound with respect to the content (usage amount) of C.I. Pigment Violet 19 in the solid solution pigment is less than 1.00, an influence on a tinge of the solid solution pigment is easily suppressed. The mass ratio of the content of the first compound with respect to the content of C.I. Pigment Violet 19 in the solid solution pigment is more preferably 0.20 or more and 0.50 or less. The above-mentioned mass ratio can be determined not only from the usage amounts but also from quantitative analysis with an apparatus using nuclear magnetic resonance spectrometry (NMR).

### [X-Ray Diffraction]

The crystal structure of the solid solution pigment can be identified by X-ray diffractometry (also referred to as “X-ray crystallography”) utilizing a phenomenon in which an X-ray shows diffraction in a crystal lattice. A peak position in the X-ray diffraction spectrum of the solid solution pigment shows a characteristic value in accordance with the kind and crystal state of the pigment. The kind and state of the pigment can be identified by the X-ray diffractometry through utilization of the foregoing.

### (Diffraction Angle)

The solid solution pigment of C.I. Pigment Violet 19 and the compound represented by the chemical formula (1) has a peak at a position of a diffraction angle 20 of 7.5°±0.2° in the X-ray diffraction spectrum of the solid solution pigment with a CuKα ray.

In addition, the solid solution pigment of C.I. Pigment Violet 19 and the compound represented by the chemical formula (2) has a peak at a position of a diffraction angle 2θ of 24.6°±0.2° in the X-ray diffraction spectrum of the solid solution pigment with a CuKα ray.

When C.I. Pigment Violet 19 and the first compound (the compound represented by the chemical formula (1) or the compound represented by the chemical formula (2)) are merely mixed and are not solid solved, no peak appears at the corresponding diffraction angle. The diffraction peak in the solid solution pigment is a peak that newly occurs when the pigment is solid solved, and means that C.I. Pigment Violet 19 and the first compound (the compound represented by the chemical formula (1) or the compound represented by the chemical formula (2)) are solid solved.

### (Intensity Ratio of Diffraction Peaks)

In the case of the solid solution pigment of C.I. Pigment Violet 19 and the compound represented by the chemical formula (1), the X-ray diffraction spectrum of the solid solution pigment with the CuKα ray preferably has the following intensity ratio of the diffraction peaks. That is, in the X-ray diffraction spectrum, the intensity ratio of the peak at a diffraction angle 2θ of 7.5°±0.2° with respect to a peak at a diffraction angle 20 of 8.0°±0.2° is preferably 1.0 times or more. The intensity ratio is more preferably 2.0 times or more, still more preferably 5.0 times or more. The peak positioned at a diffraction angle 2θ of 8.0°±0.2° is one of the peaks of the compound represented by the chemical formula (1) that is not solid solved. The intensity ratio of the diffraction peaks of 1.0 times or more indicates that the solid solving of C.I. Pigment Violet 19 and the compound represented by the chemical formula (1) has been sufficiently advanced, and thus the dispersibility of the solid solution pigment is more easily improved.

In the case of the solid solution pigment of C.I. Pigment Violet 19 and the compound represented by the chemical formula (2), the X-ray diffraction spectrum of the solid solution pigment with a CuKα ray preferably has the following intensity ratio of the diffraction peaks. That is, in the X-ray diffraction spectrum, the intensity ratio of the peak at a diffraction angle 2θ of 24.6°±0.2° with respect to a peak at a diffraction angle 2θ of 22.8°±0.2° is preferably 1.0 times or more. The intensity ratio is more preferably 2.0 times or more, still more preferably 5.0 times or more. The peak positioned at a diffraction angle 2θ of 22.8°±0.2° is one of the peaks of the compound represented by the chemical formula (2) that is not solid solved. The intensity ratio of the diffraction peaks of 1.0 times or more indicates that the solid solving of C.I. Pigment Violet 19 and the compound represented by the chemical formula (2) has been sufficiently advanced, and thus the dispersibility of the solid solution pigment is more easily improved.

### [Method of Producing Solid Solution Pigment]

As a method of producing the solid solution pigment, there may be given, for example: a method including kneading a raw material pigment while applying a load under the state in which grinding media are mixed in the pigment; and a method including mixing a raw material in polyphosphoric acid and subjecting the resultant to a ring-opening reaction. Of those, a method including kneading is preferred. Of those, a solvent salt milling method is preferred. When the solid solution pigment is produced by the solvent salt milling method, microparticles having a narrow particle size distribution are easily obtained, and hence a contact area with a water molecule or the like increases. Accordingly, the dispersibility of the solid solution pigment tends to be further improved.

The solvent salt milling method is a method including kneading a mixture containing a raw material pigment, an organic solvent, and a water-soluble inorganic salt while applying a load to compress the mixture with a kneading apparatus. The solid solution pigment is preferably a solid solution pigment obtained through a kneading step including kneading a mixture containing C.I. Pigment Violet 19 and the first compound (those materials are hereinafter sometimes referred to as “pigment-based raw materials”), an organic solvent, and a water-soluble inorganic salt with a kneading apparatus.

Kneading apparatus, such as batch-type and continuous kneading apparatus, and normal pressure-type, pressure-type, and decompression-type kneading apparatus, may each be used as the kneading apparatus, and an apparatus that kneads contents while applying a load to compress the contents may be suitably used. In addition, a kneading apparatus including, for example, a material loading portion, such as a kneading kiln or a hopper, and a stirring portion for stirring a material, such as a stirring blade, a mixing blade, a blade, a screw, or a roll, may be suitably used. Specific examples of the kneading apparatus may include kneading apparatus, such as a kneader, a roll mill, a ball mill, an attritor, a sand mill, a planetary mixer, and a continuous single-screw kneader. The planetary mixer may be, for example, TRIMIX (product name) manufactured by Inoue Mfg., Inc. In addition, the continuous single-screw kneader may be, for example, MIRACLE KCK (product name) manufactured by Asada Iron Works Co., Ltd.

The mixing ratios of the pigment-based raw materials, the organic solvent, and the water-soluble inorganic salt in the kneading step are preferably set to the following ratios with respect to the total usage amount of the pigment-based raw materials. The usage amount of the organic solvent is preferably 0.5 times or more and 5.0 times or less, more preferably 0.8 times or more and 3.0 times or less in terms of mass ratio with respect to the total usage amount of the pigment-based raw materials. The usage amount of the water-soluble inorganic salt is preferably 3.0 times or more and 20.0 times or less, more preferably 5.0 times or more and 10.0 times or less in terms of mass ratio with respect to the total usage amount of the pigment-based raw materials. In addition, a kneading time in the kneading step is preferably 2 hours or more and 8 hours or less.

### (Organic Solvent)

The organic solvent to be used in the kneading step is intended to moisten the mixture of the pigment-based raw materials and the water-soluble inorganic salt to provide dough (lump obtained by kneading) having moderate hardness. Thus, a strong load is applied to the kneaded product in the solvent salt milling method to serve to produce the crushed surface of the pigment.

The organic solvent is not particularly limited, and examples thereof may include alcohols, glycols, ethers, and aprotic polar solvents. Specific examples of the organic solvent may include 2-(methoxymethoxy)ethanol, 2-butoxyethanol, 2-(isopentyloxy)ethanol, 2-(hexyloxy)ethanol, diethylene glycol, diethylene glycol monomethyl ether, diethylene glycol monoethyl ether, diethylene glycol monobutyl ether, triethylene glycol, triethylene glycol monomethyl ether, liquid polyethylene glycol, 1-methoxy-2-propanol, 1-ethoxy-2-propanol, dipropylene glycol, dipropylene glycol monomethyl ether, dipropylene glycol monoethyl ether, low-molecular-weight polypropylene glycol, aniline, pyridine, tetrahydrofuran, dioxane, methanol, ethanol, isopropanol, n-propanol, isobutanol, n-butanol, ethylene glycol, propylene glycol, propylene glycol monomethyl ether acetate, ethyl acetate, isopropyl acetate, acetone, methyl ethyl ketone, dimethylformamide, dimethyl sulfoxide, N-methyl-2-pyrrolidone, and N,N-dimethylformamide. The above-mentioned organic solvents may be used alone or as a mixture thereof as required. Of the organic solvents, a water-soluble organic solvent is preferably used.

### (Water-Soluble Inorganic Salt)

The water-soluble inorganic salt to be used in the kneading step crushes the pigment-based raw materials in the kneading step to miniaturize the primary particles of the pigment through utilization of its high hardness. The water-soluble inorganic salt is not particularly limited as long as the inorganic salt is dissolved in water. Specific examples of the water-soluble inorganic salt may include sodium chloride, potassium chloride, sodium sulfate, zinc chloride, calcium chloride, and magnesium chloride, and a mixture of two or more kinds thereof. Of those, sodium chloride is preferably used in terms of price.

The water-soluble inorganic salt preferably has a 50% cumulative particle diameter, that is, a median particle diameter (D₅₀), in a particle size distribution on a volume basis of 1 μm or more and 250 μm or less. In particular, in order to atomize the pigment to a desired size, a water-soluble inorganic salt to be used as a grinding aid is also preferably fine. Specifically, a water-soluble inorganic salt in which the median particle diameter (D₅₀) is 1 μm or more and 10 μm or less and a 95% cumulative particle diameter (D₉₅) in the particle size distribution on a volume basis is 20 μm or less is still more preferably used. Values measured with an optical microscope may be adopted as the D₅₀ and D₉₅ of the water-soluble inorganic salt. Specifically, there is given a method including measuring particle diameters of 500 particles of the water-soluble inorganic salt with the optical microscope to calculate the D₅₀ and the D₉₅ from the particle size distribution on a volume basis.

### (Other Materials)

In the production of the solid solution pigment, in the kneading step, in addition to the pigment-based raw materials, the water-soluble inorganic salt, and the organic solvent, a dye derivative may be added for the purpose of adjusting the crystal growth and crystal dislocation of the pigment. A dye derivative using the same structure as that of each of the raw material pigments as a parent body is preferred as the dye derivative, but a dye derivative having a structure different therefrom is permitted.

In the production of the solid solution pigment, a purifying step of removing the organic solvent and the water-soluble inorganic salt from a pigment kneaded product containing the solid solution pigment obtained in the above-mentioned kneading step may be performed. A method for the purifying step is, for example, a method including mixing the pigment kneaded product and a liquid medium such as water under stirring to dissolve the organic solvent and the water-soluble inorganic salt in the pigment kneaded product in the liquid medium, and then removing the organic solvent and the water-soluble inorganic salt by filtration. After that, the amount of a liquid content such as moisture is adjusted with a dryer or the like. Thus, a pigment composition containing the solid solution pigment can be obtained. In addition, a dried solid solution pigment may also be obtained.

### <Pigment Dispersion Liquid>

The above-mentioned solid solution pigment is preferably used in the form of a pigment dispersion liquid. The pigment dispersion liquid includes a dispersion medium and the above-mentioned solid solution pigment dispersed in the dispersion medium. The pigment dispersion liquid is an aqueous pigment dispersion liquid including at least water as the dispersion medium. Deionized water or ion-exchanged water is preferably used as the water. The content (mass %) of the water in the pigment dispersion liquid is preferably 50.0 mass % or more and 95.0 mass % or less, more preferably 50.0 mass % or more and 90.0 mass % or less with respect to the total mass of the pigment dispersion liquid. The dispersion medium may be, for example, a liquid medium such as water that may be used in the production of the above-mentioned solid solution pigment, or an aqueous medium such as water that may be used in the aqueous ink to be described later. In addition, the pigment dispersion liquid may include a resin (resin dispersant) or a surfactant to be described later for dispersing the solid solution pigment in the dispersion medium.

The solid solution pigment and the pigment dispersion liquid including the pigment may be suitably used in any application as long as the application requires a coloring function. Examples of such application may include a paint, a printing ink, a colored molded article, toner for developing an electrostatic charge image, a color filter for a liquid crystal display apparatus, and an inkjet ink. Of those, an inkjet aqueous ink is preferred.

### <Ink>

An inkjet aqueous ink using the above-mentioned solid solution pigment is described below.

The ink includes the above-mentioned solid solution pigment as a coloring material. The content of the solid solution pigment in the ink is preferably 0.1 mass % or more and 15.0 mass % or less, more preferably 1.0 mass % or more and 10.0 mass % or less with respect to the total mass of the ink.

### (Pigment Dispersant)

The ink may include the resin (resin dispersant) for dispersing the pigment. As a suitable resin dispersant, there may be used a resin formed by incorporating a plurality of kinds of units derived from such monomers as described below. Examples of the monomers include: hydrophobic monomers, such as styrene, α-methylstyrene, n-butyl acrylate, n-hexyl acrylate, and benzyl methacrylate; hydrophilic monomers each having a carboxy group, such as acrylic acid, methacrylic acid, crotonic acid, ethacrylic acid, propylacrylic acid, isopropylacrylic acid, itaconic acid, and fumaric acid; hydrophilic monomers each having a sulfonic acid group, such as styrenesulfonic acid, sulfonic acid-2-propylacrylamide, acrylic acid-ethyl 2-sulfonate, methacrylic acid-ethyl 2-sulfonate, and butyl acrylamide sulfonic acid; and hydrophilic monomers each having a phosphonic acid group, such as methacrylic acid-ethyl 2-phosphonate and acrylic acid-ethyl 2-phosphonate. Of those, an acrylic resin is preferred.

The ink more preferably includes a resin having an acid value of 100 mgKOH/g or more. The acid value of the resin may be measured by an ordinary method. The acid value of the resin may be measured with, for example, a potentiometric titarator using a potassium hydroxide-ethanol titrant. In addition, the upper limit of the acid value of the resin is not particularly limited, but may be set to, for example, 250 mgKOH/g or less.

### (Surfactant)

The ink may include the surfactant for dispersing the pigment. An anionic surfactant and a nonionic surfactant are each preferred as the surfactant. Examples of the anionic surfactant include an alkylbenzene sulfonate, a higher alcohol sulfate ester salt, a higher fatty acid salt, a higher alkyl dicarboxylate, an alkyl naphthalene sulfonate, an alkyl sulfosuccinate, a naphthalene sulfonic acid formalin condensate salt, a polyoxyethylene alkyl ether sulfate, a polyoxyethylene alkyl phosphate ester, and a polyoxyethylene alkyl ether phosphate. Examples of the nonionic surfactant include a polyoxyethylene alkyl ether, a polyoxyethylene alkyl phenyl ether, a fatty acid monoglyceride, a sorbitan fatty acid ester, a polyoxyethylene sorbitan fatty acid ester, a polyoxyethylene fatty acid ester, a polyglycerol fatty acid ester, and a polyoxyethylene-added acetylene glycol. One or two or more kinds of those surfactants may be incorporated into the ink.

### (Aqueous Medium)

The ink is an aqueous ink including at least water as the aqueous medium. The water-soluble organic solvent may be further incorporated as the aqueous medium into the ink. Deionized water or ion-exchanged water is preferably used as the water. The content (mass %) of the water in the ink is preferably 50.0 mass % or more and 95.0 mass % or less, more preferably 50.0 mass % or more and 90.0 mass % or less with respect to the total mass of the ink.

In addition, any solvent that is generally used in an ink may be used as the water-soluble organic solvent. Examples thereof include alcohols, (poly)alkylene glycols, glycol ethers, nitrogen-containing compounds, and sulfur-containing compounds. One or two or more kinds of those water-soluble organic solvents may be incorporated into the ink. The content (mass %) of the water-soluble organic solvent in the ink is preferably 3.0 mass % or more and 48.0 mass % or less with respect to the total mass of the ink.

### (Other Additives)

The ink may include water-soluble organic compounds that are solid at normal temperature, the compounds including: polyhydric alcohols, such as trimethylolpropane and trimethylolethane; and urea and urea derivatives such as ethyleneurea, as required, in addition to the above-mentioned components. Further, the ink may include various additives, such as any other surfactant, a pH adjuster, a rust inhibitor, an antiseptic agent, a fungicide, an antioxidant, a reduction inhibitor, an evaporation accelerator, a chelating agent, and any other resin, as required.

### <Ink Cartridge>

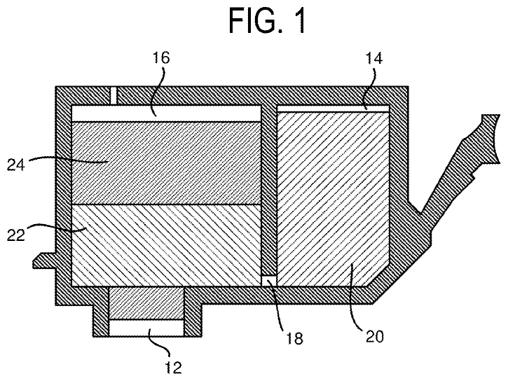

When the above-mentioned ink is used in an inkjet recording method, an ink cartridge may be used. The ink cartridge includes the above-mentioned ink and an ink storage portion for storing the ink. FIG. 1 is a sectional view for schematically illustrating an ink cartridge according to one embodiment. As illustrated in FIG. 1, an ink supply port 12 for supplying an ink to a recording head is arranged on the bottom surface of the ink cartridge. The inside of the ink cartridge is the ink storage portion for storing the ink. The ink storage portion includes an ink storage chamber 14 and an absorbent storage chamber 16 and the chambers communicate to each other through a communication port 18. In addition, the absorbent storage chamber 16 communicates to the ink supply port 12. While a liquid ink 20 is stored in the ink storage chamber 14, absorbents 22 and 24 for holding the ink in a state of being impregnated therewith are stored in the absorbent storage chamber 16. The ink storage portion may be of a form that is free of an ink storage chamber for storing the liquid ink and holds the total amount of the ink to be stored with the absorbents. In addition, the ink storage portion may be of a form that is free of an absorbent and stores the total amount of the ink in a liquid state. Further, an ink cartridge of a form configured to include the ink storage portion and a recording head is permitted.

### <Inkjet Recording Method>

An inkjet recording method is a method including ejecting the aqueous ink described above from a recording head of an inkjet system to record an image on a recording medium. A system for the ejection of the ink is, for example, a system including applying mechanical energy to the ink or a system including applying thermal energy to the ink. The system involving applying the thermal energy to the ink to eject the ink is preferably adopted for the aqueous ink described above. The step of the inkjet recording method only needs to be a known step except that the above-mentioned ink is used.

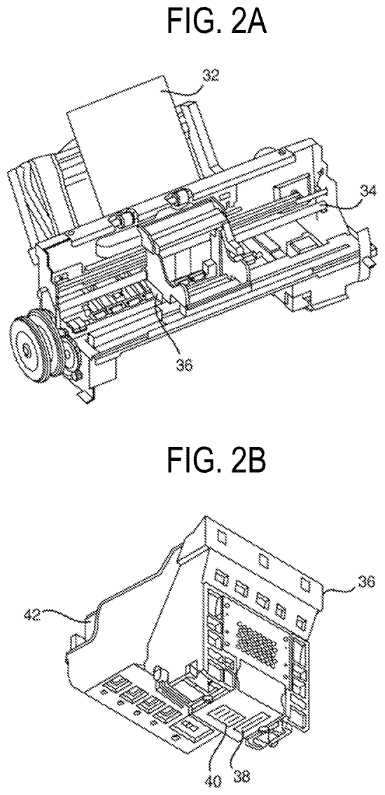

FIG. 2A and FIG. 2B are views for schematically illustrating an example of an inkjet recording apparatus to be used in the inkjet recording method, in which FIG. 2A is a perspective view of the main portion of the inkjet recording apparatus and FIG. 2B is a perspective view of a head cartridge. A conveying unit (not shown) for conveying a recording medium 32 and a carriage shaft 34 are arranged in the inkjet recording apparatus. A head cartridge 36 may be mounted on the carriage shaft 34. The head cartridge 36 includes recording heads 38 and 40 and is formed so that an ink cartridge 42 may be set therein. While the head cartridge 36 is conveyed along the carriage shaft 34 in a main scanning direction, the ink (not shown) is ejected from the recording heads 38 and 40 toward the recording medium 32. Then, the recording medium 32 is conveyed by the conveying unit (not shown) in a sub-scanning direction. Thus, the image is recorded on the recording medium 32.

According to one aspect of the present invention, the solid solution pigment using the quinacridone pigment, the solid solution pigment being excellent in dispersibility, can be provided. According to other aspects of the present invention, the aqueous pigment dispersion liquid and the aqueous ink each using the solid solution pigment can be provided.

### Examples

The present invention is described in more detail below by way of Examples and Comparative Examples. The present invention is by no means limited to Examples below without departing from the gist of the present invention. “Part(s)” and “%” with regard to the description of the amounts of components are by mass, unless otherwise stated.

### <Production of Pigment or Solid Solution Pigment>

C.I. Pigment Violet 19 (hereinafter also referred to as “PV19”) and C.I. Pigment Red 202 (hereinafter also referred to as “PR202”) were prepared as raw material pigments. In addition, a compound represented by the chemical formula (1) (5,7,12,14-pentacenetetrone) and a compound represented by the chemical formula (2) (5,12-naphthacenequinone) were prepared as first compounds. Further, sodium chloride (hereinafter also referred to as “NaCl”) having a 50% cumulative particle diameter in a particle size distribution on a volume basis of 200 μm and diethylene glycol (hereinafter also referred to as “DEG”) were prepared as a water-soluble inorganic salt and a water-soluble organic solvent, respectively.

### (Pigments or Solid Solution Pigments 1 to 16)

Respective materials (unit: part(s)) shown in Table 1 were mixed to prepare a mixture, and the mixture was kneaded with a kneading apparatus (product name: “TRIMIX”, manufactured by Inoue Mfg., Inc.) under the conditions of a temperature of 60° C. and a shear rate of 15 s⁻¹ over a kneading time (unit: hr) shown in Table 1. Through the kneading step by the solvent salt milling method, pigments or solid solution pigments 1 to 16 were produced. The mass ratio of the content of the first compound with respect to the content of C.I. Pigment Violet 19 in the produced pigment or solid solution pigment was also shown as a “mass ratio of first compound/PV19” in Table 1.

TABLE 1
Conditions for producing Pigment or Solid Solution Pigment

| Number of | | | | | | | | |
|---|---|---|---|---|---|---|---|---|
| pigment | | | | | | | | Mass ratio |
| or solid | Material (part(s)) | | | | | | Kneading | of first |
| solution | | 5,7,12,14- | 5,12- | | | | time | compound/ |
| pigment | PV19 | Pentacenetetrone | Naphthacenequinone | PR202 | NaCl | DEG | (hr) | PV19 |
| 1 | 7.0 | 3.0 | 0.0 | 0.0 | 50.0 | 10.0 | 7 | 0.43 |
| 2 | 7.0 | 0.0 | 3.0 | 0.0 | 50.0 | 10.0 | 7 | 0.43 |
| 3 | 7.0 | 3.0 | 0.0 | 0.0 | 50.0 | 10.0 | 5 | 0.43 |
| 4 | 7.0 | 3.0 | 0.0 | 0.0 | 50.0 | 10.0 | 2 | 0.43 |
| 5 | 7.0 | 0.0 | 3.0 | 0.0 | 50.0 | 10.0 | 5 | 0.43 |
| 6 | 7.0 | 0.0 | 3.0 | 0.0 | 50.0 | 10.0 | 2 | 0.43 |
| 7 | 9.0 | 1.0 | 0.0 | 0.0 | 50.0 | 10.0 | 7 | 0.11 |
| 8 | 5.0 | 5.0 | 0.0 | 0.0 | 50.0 | 10.0 | 7 | 1.00 |
| 9 | 9.5 | 0.5 | 0.0 | 0.0 | 50.0 | 10.0 | 7 | 0.05 |
| 10 | 4.0 | 6.0 | 0.0 | 0.0 | 50.0 | 10.0 | 7 | 1.50 |
| 11 | 9.0 | 0.0 | 1.0 | 0.0 | 50.0 | 10.0 | 7 | 0.11 |
| 12 | 5.0 | 0.0 | 5.0 | 0.0 | 50.0 | 10.0 | 7 | 1.00 |
| 13 | 9.5 | 0.0 | 0.5 | 0.0 | 50.0 | 10.0 | 7 | 0.05 |
| 14 | 4.0 | 0.0 | 6.0 | 0.0 | 50.0 | 10.0 | 7 | 1.50 |
| 15 | 10.0 | 0.0 | 0.0 | 0.0 | 50.0 | 10.0 | 7 | 0.00 |
| 16 | 7.0 | 0.0 | 0.0 | 3.0 | 50.0 | 10.0 | 7 | 0.00 |

### (Solid Solution Pigments 17 and 18)

Respective materials (unit: part(s)) shown in Table 2 were subjected to dehydrative cyclization for 2 hours in polyphosphoric acid heated to 100° C. Coprecipitation was performed by adding the resultant to water. Thus, solid solution pigments 17 and 18 were obtained.

TABLE 2
Conditions for producing Solid Solution Pigments

| Number | Material (part(s)) | | | Mass ratio |
|---|---|---|---|---|
| of solid | | 5,7,12,14- | | of first |
| solution | | Penta- | 5,12- | compound/ |
| pigment | PV19 | cenetetrone | Naphthacenequinone | PV19 |
| 17 | 7.0 | 3.0 | 0.0 | 0.43 |
| 18 | 7.0 | 0.0 | 3.0 | 0.43 |

### (X-Ray Diffraction)

The produced pigments or solid solution pigments 1 to 18 were each subjected to powder X-ray diffraction measurement. An X-ray diffraction pattern was measured with a CuKα ray and an X-ray diffractometer (product name: “Empyrean”, manufactured by Malvern Panalytical Ltd.). The dried pigment was ground with a mortar and was filled in a sample stage at an amount about a level of the stage, and the resultant was subjected to measurement. With regard to the solid solution pigment produced by using the compound represented by the chemical formula (1), an intensity ratio of a peak at a diffraction angle 2θ of 7.5°±0.2° with respect to a peak at a diffraction angle 2θ of 8.0°±0.2°, the peaks being observed in an X-ray diffraction spectrum, was determined. In addition, with regard to the solid solution pigment produced by using the compound represented by the chemical formula (2), an intensity ratio of a peak at a diffraction angle 2θ of 24.6°±0.2° with respect to a peak at a diffraction angle 2θ of 22.8°±0.2°, the peaks being observed in an X-ray diffraction spectrum, was determined. The results are shown in Table 3.

TABLE 3
Results of X-ray Diffraction Measurement of Pigments or Solid Solution Pigments

| Number | Presence or absence | | Presence or absence | |
|---|---|---|---|---|
| of | of peak at | Peak | of peak at | |
| pigment | diffraction | intensity | diffraction | Peak |
| or solid | angle 2θ of | ratio | angle 2θ of | intensity ratio |
| solution | 7.5° ± 0.2° | 7.5° ± 0.2°/ | 24.6° ± 0.2° | 24.6° ± 0.2°/ |
| pigment | (present: ∘, absent: x) | 8.0° ± 0.2° | (present: ∘, absent: x) | 22.8° ± 0.2° |
| 1 | ∘ | 10.0 | x | — |
| 2 | x | — | ∘ | 10.0 |
| 3 | ∘ | 1.0 | x | — |
| 4 | ∘ | 0.5 | x | — |
| 5 | x | — | ∘ | 1.0 |
| 6 | x | — | ∘ | 0.5 |
| 7 | ∘ | 10.0 | x | — |
| 8 | ∘ | 10.0 | x | — |
| 9 | ∘ | 10.0 | x | — |
| 10 | ∘ | 10.0 | x | — |
| 11 | x | — | ∘ | 10.0 |
| 12 | x | — | ∘ | 10.0 |
| 13 | x | — | ∘ | 10.0 |
| 14 | x | — | ∘ | 10.0 |
| 15 | x | — | x | — |
| 16 | x | — | x | — |
| 17 | ∘ | 10.0 | x | — |
| 18 | x | — | ∘ | 10.0 |

### <Synthesis of Resin and Preparation of Resin Aqueous Solution>

Resins 1 to 3 each having constituent ratios (unit: %) of units derived from respective monomers shown in Table 4 were synthesized by an ordinary method using monomers shown in Table 4. In addition, the acid values of the respective synthesized resins (mgKOH/g) were also shown in Table 4. The obtained resins 1 to 3 were each neutralized with a 10.0% potassium hydroxide aqueous solution so as to be equivalent to its acid value to form a resin aqueous solution. The contents (solid contents) of the resins in the resin aqueous solutions were each 20.0%.

TABLE 4
Resin

| | Constituent ratios of units | | |
|---|---|---|---|
| | for forming resin (%) | | Acid |
| Number | | Acrylic | value |
| of resin | Styrene | acid | (mgKOH/g) |
| 1 | 84.6 | 15.4 | 120 |
| 2 | 87.1 | 12.9 | 100 |
| 3 | 89.7 | 10.3 | 80 |

### <Preparation of Pigment Dispersion Liquid>

### (Pigment Dispersion Liquids 1 to 22)

Pigment dispersion liquids 1 to 22 were prepared by using the pigments or solid solution pigments 1 to 18 and the aqueous solutions of the resins 1 to 3 obtained above. Specifically, 16.0 parts of the pigment or solid solution pigment whose kind (No.) was shown in Table 5, 24.0 parts of the resin aqueous solution whose kind (No.) was shown in Table 5, and ion-exchanged water as the balance so that the total amount became 100.0 parts were mixed. The resultant mixture was subjected to dispersion treatment over 2 hours through use of a batch-type vertical sand mill, and was then subjected to centrifugation treatment so that coarse particles were removed. Next, the resultant was filtered under pressure through a microfilter (manufactured by FUJIFILM Corporation) having a pore size of 3.0 μm. Thus, pigment dispersion liquids 1 to 22 were obtained. The contents of the pigments in the pigment dispersion liquids 1 to 22 were each 16.0%.

TABLE 5
Pigment Dispersion Liquid

| | Number of | Number of |
|---|---|---|
| Number of | pigment or | resin in |
| pigment | solid | resin |
| dispersion | solution | aqueous |
| liquid | pigment | solution |
| 1 | 1 | 1 |
| 2 | 17 | 1 |
| 3 | 2 | 1 |
| 4 | 18 | 1 |
| 5 | 3 | 1 |
| 6 | 4 | 1 |
| 7 | 5 | 1 |
| 8 | 6 | 1 |
| 9 | 7 | 1 |
| 10 | 8 | 1 |
| 11 | 9 | 1 |
| 12 | 10 | 1 |
| 13 | 11 | 1 |
| 14 | 12 | 1 |
| 15 | 13 | 1 |
| 16 | 14 | 1 |
| 17 | 1 | 2 |
| 18 | 1 | 3 |
| 19 | 2 | 2 |
| 20 | 2 | 3 |
| 21 | 15 | 1 |
| 22 | 16 | 1 |

### (Pigment Dispersion Liquid 23)

5.0 Parts of the solid solution pigment 17 obtained above, 2.0 parts of sodium dodecylbenzene sulfonate serving as an anionic surfactant, and ion-exchanged water as the balance so that the total amount became 100.0 parts were mixed. The resultant mixture was subjected to dispersion treatment over 7 hours with Paint Conditioner (manufactured by Red Devil) and zirconia beads each having a diameter of 0.1 mm in an amount twice as large as that of the mixture. Thus, a pigment dispersion liquid 23 was obtained. The content of the pigment in the pigment dispersion liquid 23 was 5.0%.

### (Pigment Dispersion Liquid 24)

A pigment dispersion liquid 24 was obtained in the same manner as in the method of preparing the pigment dispersion liquid 23 except that the solid solution pigment 17 used in the preparation of the pigment dispersion liquid 23 was changed to the solid solution pigment 18. The content of the pigment in the pigment dispersion liquid 24 was 5.0%.

### (Pigment Dispersion Liquid 25)

11.2 Parts of PV19 kneaded with a kneading apparatus (product name: “TRIMIX”, manufactured by Inoue Mfg., Inc.), 4.8 parts of the compound represented by the chemical formula (1) kneaded in the same manner, 24.0 parts of the aqueous solution of the resin 1, and ion-exchanged water as the balance so that the total amount became 100.0 parts were mixed. The resultant mixture was subjected to dispersion treatment over 2 hours through use of a batch-type vertical sand mill, and was then subjected to centrifugation treatment so that coarse particles were removed. Next, the resultant was filtered under pressure through a microfilter (manufactured by FUJIFILM Corporation) having a pore size of 3.0 μm. Thus, a pigment dispersion liquid 25 was obtained. The content of the pigment in the pigment dispersion liquid 25 was 16.0%. Conditions for the kneading of each of PV19 and the compound represented by the chemical formula (1) were set to a temperature of 60° C., a shear rate of 15 s⁻¹, and a kneading time of 7 hours.

### (Pigment Dispersion Liquid 26)

A pigment dispersion liquid 26 was obtained in the same manner as in the method of preparing the pigment dispersion liquid 25 except that the compound represented by the chemical formula (1) used in the preparation of the pigment dispersion liquid 25 was changed to the compound represented by the chemical formula (2). The content of the pigment in the pigment dispersion liquid 26 was 16.0%.

### <Preparation of Ink>

The pigment dispersion liquid whose kind (No.) and usage amount (unit: part(s)) were shown in Table 6, 10.0 parts of glycerin, 5.0 parts of triethylene glycol, 1.0 part of a surfactant, and ion-exchanged water as the balance so that the total amount became 100.0 parts were sufficiently stirred. After that, the resultant was filtered under pressure through a microfilter (manufactured by FUJIFILM Corporation) having a pore size of 0.45 μm. Thus, respective inks were prepared. A product available under the product name “ACETYLENOL E100” from Kawaken Fine Chemicals Co., Ltd. was used as the above-mentioned surfactant.

TABLE 6
Preparation of Ink

Pigment dispersion liquid

| Number | Kind | Usage amount |
|---|---|---|
| of ink | (No.) | (part(s)) |
| 1 | 1 | 18.8 |
| 2 | 2 | 18.8 |
| 3 | 3 | 18.8 |
| 4 | 4 | 18.8 |
| 5 | 5 | 18.8 |
| 6 | 6 | 18.8 |
| 7 | 7 | 18.8 |
| 8 | 8 | 18.8 |
| 9 | 9 | 18.8 |
| 10 | 10 | 18.8 |
| 11 | 11 | 18.8 |
| 12 | 12 | 18.8 |
| 13 | 13 | 18.8 |
| 14 | 14 | 18.8 |
| 15 | 15 | 18.8 |
| 16 | 16 | 18.8 |
| 17 | 23 | 60.0 |
| 18 | 24 | 60.0 |
| 19 | 17 | 18.8 |
| 20 | 18 | 18.8 |
| 21 | 19 | 18.8 |
| 22 | 20 | 18.8 |
| 23 | 21 | 18.8 |
| 24 | 22 | 18.8 |
| 25 | 25 | 18.8 |
| 26 | 26 | 18.8 |

### <Evaluation>

The respective prepared inks were subjected to the following evaluation. In Examples of the present invention, in the evaluation criteria of each item described below, levels “A” and “B” were defined as acceptable levels, and a level “C” was defined as an unacceptable level. The evaluation results are shown in Table 7.

### (Dispersion Stability)

The 50% cumulative particle diameter (hereinafter referred to as “D1”) of each of the inks in a particle size distribution on a volume basis was measured. In addition, each of the inks was loaded into a closed vessel and was stored in an oven at 80° C. for 4 days.

After that, the 50% cumulative particle diameter (hereinafter referred to as “D2”) of the ink returned to normal temperature (25° C.) in a particle size distribution on a volume basis was measured. The change ratio=D2/D1 (times) of the particle diameter before and after the storage was calculated, and the dispersion stability (storage stability) of the ink was evaluated in accordance with evaluation criteria described below.
A: The change ratio (D2/D1) of the particle diameter was less than 1.05 times.
B: The change ratio (D2/D1) of the particle diameter was 1.05 times or more and less than 1.20 times.
C: The change ratio (D2/D1) of the particle diameter was 1.20 times or more.

The 50% cumulative particle diameter of each of the inks in a particle size distribution on a volume basis was measured by a method described below. A particle size distribution on a volume basis of a sample obtained by diluting each of the inks with ion-exchanged water was measured with a particle size distribution-measuring device (product name: “Nanotrac WaveII-EX150”, manufactured by MicrotracBEL Corp.) by a dynamic light scattering method. Measurement conditions were set to the following conditions: SetZero: 30 seconds; number of times of measurement: 3 times; measurement time: 180 seconds; and refractive index: 1.5.

TABLE 7
Evaluation Results

| | | | Evaluation |
|---|---|---|---|
| | Number | Number of pigment | (dispersion |
| | of ink | dispersion liquid | stability) |
| Example 1 | 1 | 1 | A |
| Example 2 | 2 | 2 | B |
| Example 3 | 3 | 3 | A |
| Example 4 | 4 | 4 | B |
| Example 5 | 5 | 5 | A |
| Example 6 | 6 | 6 | B |
| Example 7 | 7 | 7 | A |
| Example 8 | 8 | 8 | B |
| Example 9 | 9 | 9 | A |
| Example 10 | 10 | 10 | A |
| Example 11 | 11 | 11 | B |
| Example 12 | 12 | 12 | B |
| Example 13 | 13 | 13 | A |
| Example 14 | 14 | 14 | A |
| Example 15 | 15 | 15 | B |
| Example 16 | 16 | 16 | B |
| Example 17 | 17 | 23 | B |
| Example 18 | 18 | 24 | B |
| Example 19 | 19 | 17 | A |
| Example 20 | 20 | 18 | B |
| Example 21 | 21 | 19 | A |
| Example 22 | 22 | 20 | B |
| Comparative Example 1 | 23 | 21 | C |
| Comparative Example 2 | 24 | 22 | C |
| Comparative Example 3 | 25 | 25 | C |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-045793, filed Mar. 22, 2023, and Japanese Patent Application No. 2024-034106, filed Mar. 6, 2024, which are hereby incorporated by reference herein in their entirety.

What is claimed is:

1. A solid solution pigment of C.I. Pigment Violet 19 and a first compound,
wherein the first compound is one of a compound represented by the following chemical formula (1) or a compound represented by the following chemical formula (2).

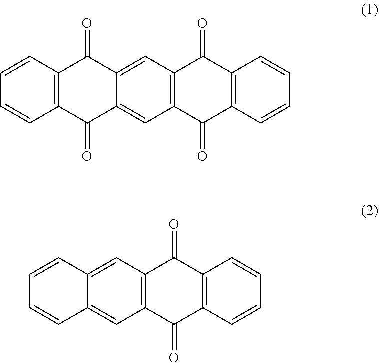 [SMILES: O=c1c2ccccc2c(=O)c2cc3c(=O)c4ccccc4c(=O)c3cc12 ; O=C1c2ccccc2C(=O)c2cc3ccccc3cc21]

2. The solid solution pigment according to claim 1,
wherein the first compound is the compound represented by the chemical formula (1), and
wherein, in an X-ray diffraction spectrum of the solid solution pigment with a CuKα ray, the solid solution pigment has a peak at a position of a diffraction angle 2θ of 7.5°±0.2°.

3. The solid solution pigment according to claim 2, wherein, in the X-ray diffraction spectrum of the solid solution pigment with the CuKα ray, an intensity ratio of the peak at a diffraction angle 2θ of 7.5°±0.2° with respect to a peak at a diffraction angle 2θ of 8.0°±0.2° is 1.0 times or more.

4. The solid solution pigment according to claim 1,
wherein the first compound is the compound represented by the chemical formula (2), and
wherein, in an X-ray diffraction spectrum of the solid solution pigment with a CuKα ray, the solid solution pigment has a peak at a position of a diffraction angle 2θ of 24.6°±0.2°.

5. The solid solution pigment according to claim 4, wherein, in the X-ray diffraction spectrum of the solid solution pigment with the CuKα ray, an intensity ratio of the peak at a diffraction angle 2θ of 24.6°±0.2° with respect to a peak at a diffraction angle 2θ of 22.8°±0.2° is 1.0 times or more.

6. The solid solution pigment according to claim 1, wherein a mass ratio of a content of the first compound with respect to a content of the C.I. Pigment Violet 19 in the solid solution pigment is 0.10 or more and less than 1.00.

7. An aqueous pigment dispersion liquid comprising a solid solution pigment of C.I. Pigment Violet 19 and a first compound,
wherein the first compound is one of a compound represented by the following chemical formula (1) or a compound represented by the following chemical formula (2).

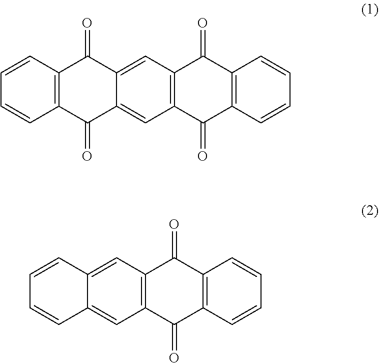 [SMILES: O=c1c2ccccc2c(=O)c2cc3c(=O)c4ccccc4c(=O)c3cc12 ; O=C1c2ccccc2C(=O)c2cc3ccccc3cc21]

8. An aqueous ink comprising a solid solution pigment of C.I. Pigment Violet 19 and a first compound,
wherein the first compound is one of a compound represented by the following chemical formula (1) or a compound represented by the following chemical formula (2).

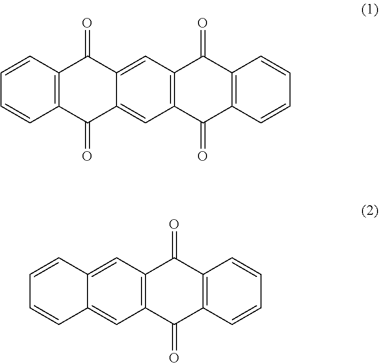 [SMILES: O=c1c2ccccc2c(=O)c2cc3c(=O)c4ccccc4c(=O)c3cc12 ; O=C1c2ccccc2C(=O)c2cc3ccccc3cc21]

9. The aqueous ink according to claim 8, further comprising a resin having an acid value of 100 mgKOH/g or more.
